(19) United States
(12) Patent Application Publication
(10) Pub. No.: US 2014/0279366 A1
(43) Pub. Date: Sep. 18, 2014

(54) Method and Apparatus for Generating and Facilitating the Application of Trading Algorithms Across a Multi-Source Liquidity Market

(71) Applicant: Integral Development Inc., Palo Alto, CA (US)

(72) Inventors: Harpal Sandhu, Palo Alto, CA (US); Vikas Srivastava, Palo Alto, CA (US); Jon Barker, London (GB)

(21) Appl. No.: 14/214,121

(22) Filed: Mar. 14, 2014

Related U.S. Application Data
(60) Provisional application No. 61/791,369, filed on Mar. 15, 2013.

(51) Int. Cl. G06Q 40/04

(52) U.S. Cl. CPC G06Q 40/04
USPC 705/37

(57) ABSTRACT

A computer-implemented method is provided for generating one or more trading algorithms, comprising the steps of: (i) generating, via one or more processing units, display data representing a plurality of user configurable trading algorithm parameters; (ii) obtaining, from a user, algorithm parameter information, wherein the algorithm parameter information comprises information defining at least one characteristic of at least one user configurable trading algorithm parameter of the plurality of user configurable trading algorithm parameters; (iii) generating the one or more trading algorithms based, at least in part, on the algorithm parameter information; and (iv) facilitating one or more trades in a liquidity market using the one or more generated trading algorithms.

### CROSS-REFERENCE TO RELATED APPLICATIONS AND PRIORITY CLAIM

This application claims priority to U.S. provisional patent application No. 61/791,369, entitled “Method, System, and Apparatus for Generating and Facilitating the Application of Trading Algorithms Across a Multi-Source Liquidity Market,” filed Mar. 15, 2013. This application is also related to, and incorporates herein in its entirety, U.S. provisional patent application No. 61/794,585 entitled “Method, System, and Apparatus for Generating and Operating a Swaps Trading Platform,” filed Mar. 15, 2013.

This application is also related to U.S. provisional patent application Ser. No. 61/747,698, filed Dec. 31, 2012, titled “Methods and Systems for Facilitating Financial Exchanges Between Liquidity Takers and Liquidity Providers.” In addition, this application is related to U.S. patent application Ser. No. 12/984,651, filed Jan. 5, 2011, titled “Systems and Methods for Conducting Financial Transactions,” which is a continuation of U.S. patent application Ser. No. 10/911,076, filed Aug. 3, 2004, titled “Systems and Methods of Conducting Financial Transactions,” which is a continuation-in-part of U.S. patent application Ser. No. 09/703,198 filed Oct. 31, 2000, titled “System and Method for Conducting Web-Based Financial Transactions in Capital Markets,” the entirety of all of which are hereby incorporated by reference. This application also incorporates in its entirety herein by reference each of: (i) U.S. provisional patent application Ser. No. 60/139,113 filed Jun. 14, 1999, titled “System and Method for an XML Vocabulary for Capital Markets”; (ii) U.S. provisional patent application Ser. No. 60/162,873 filed Nov. 1, 1999, titled “Method and Apparatus for Web-Based Management of Financial Risk and Pricing and Trading of Financial Products”; (iii) U.S. patent application Ser. No. 09/593,324 filed Jun. 13, 2000, titled “System and Method for Conducting Web-Based Financial Transactions in Capital Markets,” now U.S. Pat. No. 6,347,307; (iv) U.S. provisional patent application Ser. No. 61/035,655 filed Mar. 11, 2008, titled “System and Method for Conducting Web-Based Financial Transactions in Capital Markets”; and (v) U.S. patent application Ser. No. 12/402,370 filed Mar. 11, 2009, titled “System and Method for Conducting Web-Based Financial Transactions in Capital Markets.” Each of the foregoing is assigned to the assignee of the present invention.

### FIELD

The instant disclosure relates generally to the trading of financial instruments and, more specifically, to a method and apparatus for generating and facilitating the application of trading algorithms across a multi-source liquidity market.

### BACKGROUND

Algorithmic trading refers to the use of electronic platforms for entering trading orders via an algorithm configured to execute pre-programmed trading instructions. Algorithmic trading may be employed to trade a diverse array of financial instruments, including, but not limited to, securities (e.g., stocks, bonds, etc.), cash instruments (e.g., certificates of deposit, etc.), exchange traded derivatives, over-the-counter (OTC) derivatives (e.g., foreign exchange swaps, currency swaps, interest rate swaps, etc.), etc. Algorithmic trading is widely used by investment banks, pension funds, mutual funds, and other buy-side (investor-driven) institutional traders. Typically, algorithmic trading is used in order to divide large trades into several smaller trades so as to manage market impact and risk and provide anonymity to the user. Sell side traders, such as market makers and some hedge funds, provide liquidity to the market, generating and executing orders automatically.

Recently, algorithmic trading has become exceedingly prevalent. For example, nearly a third of all European Union and United States stock trades in 2006 were driven by automatic programs, or “algos,” according to Boston-based financial services industry research and consulting firm Aite Group. Despite the prevalence of algorithmic trading, there are still a number of drawbacks associated with conventional algorithmic trading systems.

Historically, sources including liquidity providers such as banks have offered in-house (i.e., proprietary) algorithms to investors, hedge funds, corporations, and other banks. In addition, in the past, algorithmic trading did not offer liquidity over multi-source markets because banks tended to offer only their own liquidity. This does not create significant issues when the instruments being traded by the algos are equities, because there is an agency relationship in place between the customer and its bank. In an agency relationship, the “agent” (the bank or broker) has a fiduciary duty to represent the client's best interests. This fiduciary duty precludes the agent acting as the counterparty in a trade. The agent can only “pass through” a price from another party in the market.

However, significant issues arise when algos are used for trading on, for example, the foreign exchange (“forex” or “FX”) market. In the FX market, there is not an agency relationship between the customer and its broker/bank. Rather, the bank is the counterparty in these types of trade. Acting as the counterparty creates a significant conflict of interest.

Moreover, conventionally, the in-house algorithms supplied by sources such as banks are effectively “black-box” algos. That is to say, the party who is trading using the proprietary algorithm (a) does not know how the algorithm operates and (b) has limited and incomplete control over the design of the algorithm. This limits the customer's ability to design, configure, deploy, and monitor the algorithm. As such, the trading party is left to simply “trust” that the source's (e.g., bank's) algorithm is optimal for that party's trading needs and goals, without any ability to perform meaningful checks or implement meaningful changes to the proprietary algorithm. Accordingly, for FX, there is a need for trading algorithms with published and configurable parameters, permitting traders to better understand the algorithms they are employing, thereby increasing transparency.

Further still, conventional trading algorithms are static in nature. Conventional trading algorithms are incapable of switching trading strategies based on market conditions, switching between liquidity sources based on the depth of the market, or taking historical performance data into account in their design.

Simply stated, in conventional algo trading systems in FX, traders are left to trade using opaque algos whose composition and functionality are unknown, traders are often limited to trading with a single bank, and the algorithms themselves are inflexible, unconfigurable, and incapable of dynamic changes in response to the market.

### SUMMARY

In response to the above-noted drawbacks of the present FX trading environment, the instant disclosure provides a method and apparatus aimed at alleviating the drawbacks of conventional algorithmic trading technology. Specifically, it provides a neutral technology platform, capable of customization, to facilitate the execution of foreign exchange OTC trades, and additional types of trades known in the art, across a multi-source liquidity market.

The instant disclosure describes a method and apparatus for generating and facilitating the application of trading algorithms across a multi-source liquidity market. To this end, in one example, a method for generating a transparent trading algorithm is provided. The method may include (i) generating a plurality of configurable algorithm parameters, (ii) obtaining algorithm parameter information, wherein the algorithm parameter information comprises information defining at least one characteristic for at least one user-configurable algorithm parameter of the plurality of configurable algorithm parameters, and (iii) generating at least one trading algorithm based, at least in part, on the algorithm parameter information.

In another example, the method may additionally include (i) generating a plurality of trading strategies, (ii) obtaining strategy selection information, wherein strategy selection information comprises information defining at least one trading strategy of the plurality of trading strategies, and/or (iii) generating at least one trading algorithm is based at least in part on the strategy selection information.

In still another example, the method may additionally include (i) facilitating one or more trades in a liquidity market using the generated trading algorithm, (ii) analyzing the performance of the generated trading algorithm over a period of time to generate historical performance information, and (iii) generating a new trading algorithm based on the historical performance information

### BRIEF DESCRIPTION OF THE DRAWINGS

FIG. 1 illustrates a representative computing device 100 that may be used to implement the teachings of the instant disclosure;

FIG. 2 is a block diagram illustrating one example of a computing apparatus 200 for implementing the teachings of the instant disclosure;

FIG. 3 illustrates another exemplary embodiment comprising a method for generating a trading algorithm;

FIG. 4 is a screenshot from one embodiment of the disclosure, illustrating user-configurable trading algorithm parameters and user-provided algorithm parameter information for a TWAP order;

FIG. 5 is a screenshot from one embodiment of the disclosure, illustrating user-configurable trading algorithm parameters and user-provided algorithm parameter information for a Switch order; and

FIG. 6 is a screenshot from one embodiment of the disclosure, illustrating user-configurable trading algorithm parameters and user-provided algorithm parameter information for a Peg order.

### DETAILED DESCRIPTION

To facilitate an understanding of the principals and features of the disclosed technology, illustrative embodiments are explained below. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It must also be noted that, as used in the specification and the appended claims, the singular forms “a,” “an” and “the” include plural referents unless the context clearly dictates otherwise.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

As used herein, obtaining information is understood to comprise both actively retrieving information (“fetching” it) and passively receiving it. It is also understood by one skilled in the art that a parameter may also refer to a dimension, a variable, an input, or another synonym or term for information obtained by a system, apparatus, or method. As used herein, user refers to any participant in a liquidity market that is not a liquidity provider. As understood by those skilled in the art, particular entities or individuals may alternate between being a user and a liquidity provider, depending on the role they play in a particular transaction.

As used herein, logic refers to elements of an apparatus that operate on or produce data or information. Logic elements may be implemented using firmware and/or hardware devices such as application specific integrated circuits (ASICs), programmable logic arrays, state machines, etc.

As used herein, components or elements that are operatively connected are understood to share or transfer information between each other. For example, they may be communicatively coupled, either directly or via one or more intermediaries. As a other example they may be operatively connected via an information network such as the Internet or the World Wide Web.

Various embodiments of the disclosed technology provide a method, system, and apparatus for generating a transparent trading algorithm. The method may include (i) generating a plurality of configurable algorithm parameters, (ii) obtaining algorithm parameter information, wherein the algorithm parameter information comprises information defining at least one characteristic for at least one user-configurable algorithm parameter of the plurality of configurable algorithm parameters, and (iii) generating at least one trading algorithm based, at least in part, on the algorithm parameter information.

In another example embodiment, a computing apparatus comprises a plurality of logical elements configured to (i) generate a plurality of configurable algorithm parameters, (ii) obtain algorithm parameter information, wherein the algorithm parameter information comprises information defining at least one value for at least one configurable algorithm parameter of the plurality of configurable algorithm parameters, and (iii) generate a trading algorithm based, at least in part, on the algorithm parameter information.

In another example embodiment, a computer program product embodied in a non-transitory computer-readable medium comprising an algorithm adapted to effectuate a method is provided. The method may additionally include (i) facilitating one or more trades in a liquidity market using the generated trading algorithm, (ii) analyzing the performance of the generated trading algorithm over a period of time to generate historical performance information, and/or (iii) generating a new trading algorithm based on the historical performance information.

Referring now to the Figures, in which like reference numerals represent like parts, various embodiments of the computing devices and methods will be disclosed in detail. FIG. 1 is a block diagram illustrating one example of a computing device 100 suitable for use in generating and facilitating the application of trading algorithms across a multi-source liquidity market.

FIG. 1 illustrates a representative computing device 100 that may be used to implement the teachings of the instant disclosure. The device 100 includes one or more processors 102 operatively connected to a storage component 104. The storage component 104, in turn, includes stored executable instructions 116 and data 118. In an embodiment, the processor(s) 102 may include one or more of a microprocessor, microcontroller, digital signal processor, co-processor or the like or combinations thereof capable of executing the stored instructions 116 and operating upon the stored data 118. Likewise, the storage component 104 may include one or more devices such as volatile or nonvolatile memory including but not limited to random access memory (RAM) or read only memory (ROM). Further still, the storage component 104 may be embodied in a variety of forms, such as a hard drive, optical disc drive, floppy disc drive, flash memory, on a network server, the “cloud,” etc. Processor and storage arrangements of the types illustrated in FIG. 1 are well known to those having ordinary skill in the art. In one embodiment, the processing techniques described herein are implemented as a combination of executable instructions and data within the storage component 104.

As shown, the computing device 100 may include one or more user input devices 106, a display 108, a peripheral interface 110, other output devices 112, and a network interface 114 in communication with the processor(s) 102. The user input device 106 may include any mechanism for providing user input to the processor(s) 102. For example, the user input device 106 may include a keyboard, a mouse, a touch screen, microphone and suitable voice recognition application, or any other means whereby a user of the device 100 may provide input data to the processor(s) 102. The display 108 may include any conventional display mechanism such as a cathode ray tube (CRT), flat panel display, projector, or any other display mechanism known to those having ordinary skill in the art. In an embodiment, the display 108, in conjunction with suitable stored instructions 116, may be used to implement a graphical user interface. Implementation of a graphical user interface in this manner is well known to those having ordinary skill in the art. The peripheral interface 110 may include the hardware, firmware and/or software necessary for communication with various peripheral devices, such as media drives (e.g., magnetic disk or optical disk drives), other processing devices, or any other input source used in connection with the instant techniques. Likewise, the other output device(s) 112 may optionally include similar media drive mechanisms, other processing devices, or other output destinations capable of providing information to a user of the device 100, such as speakers, LEDs, tactile outputs, etc. Finally, the network interface 114 may include hardware, firmware, and/or software that allows the processor(s) 102 to communicate with other devices via wired or wireless networks, whether local or wide area, private or public, as known in the art. For example, such networks may include the World Wide Web or Internet, or private enterprise networks, as known in the art.

While the computing device 100 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the device 100 may include a greater or lesser number of components than those illustrated. Once again, those of ordinary skill in the art will appreciate the wide number of variations that may be used is this manner. Further still, although a single computing device 100 is illustrated in FIG. 1, it is understood that a combination of such computing devices may be configured to operate in conjunction (for example, using known networking techniques) to implement the teachings of the instant disclosure.

FIG. 2 is a block diagram illustrating one example of a computing apparatus 200 for implementing the teachings of the instant disclosure. As shown, computing apparatus 200 comprises a plurality of logical elements 201, including display logic 202, algorithm logic 204, trade facilitating logic 208, performance analyzing logic 218, liquidity provider logic 220, order-dividing logic 222, randomizing logic 224, order-linking logic 226, and order-pricing logic 228. The first logical element comprises display logic 202 which generates a plurality of user-configurable trading algorithm parameters 250 which are communicated to a user 206.

Computing apparatus 200 is shown as being operatively connected to a liquidity market 210. For example, computing apparatus 200 may be operatively connected to the liquidity market 210 via one or more networks (e.g., the Internet), as will be appreciated by those having ordinary skill in the art. The liquidity market 210 includes one or more users 214 and one or more liquidity providers 212.

In operation, computing apparatus 200 functions as follows. Display logic 202 generates a plurality of user-configurable trading algorithm parameters 250. The plurality of user-configurable trading algorithm parameters 250 are communicated to a user 206. The user-configurable trading algorithm parameters 250 may be communicated to a user 206 via a display unit, a loudspeaker, a communications network, any combination of the three, or via an equivalent communications technology. The algorithm logic 204 obtains algorithm parameter information 252 from the user 206. The algorithm parameter information 252 comprises information defining at least one characteristic of at least one user-configurable trading algorithm parameters 250.

In one embodiment, algorithm parameter information 252 may include, but is not limited to, such parameters as (i) total execution time, (ii) execution start time, (iii) execution end time, (iv) no worse than price also known as limit price (v) market range also known as slippage, (vi) trigger level, (vii) action at expiry, (viii) aggressive/passive execution and (ix) disclosed/anonymous execution.

The algorithm parameter information 252 may be obtained directly by the algorithm logic 204, or it may be obtained through one or more of the logic elements of the plurality 201. For example, in another embodiment, the algorithm parameter information may include, but is not limited to, liquidity provider information 254, order-dividing information 256, order-randomizing information 258, order-linking information 260, or order-pricing information 262.

Liquidity provider information 254 may include, but is not limited, to defining permissible liquidity providers for a given transaction or series of transactions.

Order-dividing information 256 may include, but is not limited to instructions to divide one or more orders into smaller orders. For example, order-dividing information may include instructions to execute an order according to time-weighted average pricing (“TWAP”), volume-weighted average pricing (“VWAP”), or both. In TWAP execution, a large order is divided into smaller sub-orders of a defined size (“Clip Size), or range of sizes, and these smaller sub-orders are then executed at defined time intervals (“Clip Time Interval”), or range of time intervals. In VWAP execution, a large order is divided into smaller orders based on what is known by practitioners of the art as “Top of Book” (that is, the best price and the associated size), and continuously executed at Top of Book until there is no remaining balance to the original large order. A VWAP order may further define a “regular size”, which is the minimum acceptable size of a “Top of Book” execution.

Order-randomizing information 258 may include, but is not limited to instructions to randomize parameters of an order, such as the timing or size of divided orders.

Order-linking information 260 may include, but is not limited to selecting a plurality of orders to be linked and instructions to cancel the remaining linked orders when one order of the plurality of orders executes.

Order-pricing information 262 may include, but is not limited to instructions to buy or sell at particular prices. The buying or selling prices may be based on a bid, an offer, a midpoint between a bid and offer, or a fixed offset from a bid, offer, or midpoint. In one example, order-pricing information 262 may include a “Limit” order, in which one order is sent to market to be executed at, or better than, a defined price, at whatever size is available. In another example, order-pricing information may include a “Market” order, in which one order is sent to market to be executed at whatever price and size is available. In another example, order-pricing information may include a “Fill or Kill” order, in which one order is sent to market to be executed at the defined size, at whatever price is available, i.e. it will not execute at another size. In another example, order-pricing information may include a “Take Profit/Stop Loss” order, in which a customer holding a position (i.e. holding risk) can close their position by either taking profit at a defined price or closing at a loss at a defined price, whichever occurs first.

In another example, the algorithm parameter information may include both order-dividing information 256 and order-randomizing information 258. One such example might be a “Time slicing” order, which is similar to a TWAP, but with the additional option to randomize the size and the timing of the sub-orders. In this example, additional algorithm parameter information 252 may include (i) a “Clip Time Interval;” (ii) an instruction to randomize the Clip Time Interval, within a user-defined range; (iii) “Clip Size;” and (iv) an instruction to randomize the Clip Size, within a user-defined range.

In another example, the algorithm parameter information 252 may include both order-dividing information 256 and order-pricing information 262. One such example would be a “Peg” order, in which a large order is divided into smaller sub-orders with a defined size or range of sizes, and these smaller sub-orders are then executed at a price that falls within the defined range of prices (“offset”) that surrounds a benchmark prices (e.g. the current market price).

Another example including both order-dividing information 256 and order-pricing information 262 would be an “Iceberg” order. An Icerberg order comprises a Peg order with the following additional user-configurable trading algorithm parameters 250: (i) whether to display a smaller order size, (ii) what size to display, and (iii) whether to reandomize the displayed size, within a user-defined range.

Another example including both order-dividing information 256 and order-pricing information 262 would be a “Switch” order. In a Switch, a large order is divided into smaller sub-orders with a defined size, or range of sizes. This is similar to a “Time Slicing” order, except that these smaller sub-orders alternate, or “switch” between executing as a Peg or a Market order. The Market orders are linked to the Peg orders, such that each Market order is cancelled or modified based upon the execution results of the Peg order immediately preceding it.

The algorithm logic 204 generates one or more trading algorithms 274 based on the algorithm parameter information 252 obtained from the user 206. The trade facilitating logic 208 facilitates trades 276 in the liquidity market 210 based on the one or more algorithms 274 generated by the algorithm logic 204. In at least one embodiment, the liquidity market 210 comprises a plurality of liquidity providers 212 and a plurality of users 214.

In a further example, the performance analyzing logic 218 obtains historical performance information 278 from the liquidity market 210 about facilitated trades 276, which were based on algorithm information 274. The performance analyzing logic 218 generates performance analysis information 282 and communicates the performance analysis information 282 to the algorithm logic 204. The algorithm logic 204 generates one or more new algorithms 284 based on the performance analysis information 282. The trade facilitating logic 208 facilitates new trades 286 based on the new algorithms 284. In one example, historical performance data involves the performance of particular liquidity providers. If their rejection rate is high and exceeds a certain threshold, this analysis can generate changes to the algorithm.

In another example, the liquidity provider logic 220 obtains liquidity provider information 254 from a user 206, generates liquidity provider algorithm information 266, and communicates the liquidity provider algorithm information 266 to the algorithm logic 204. The algorithm logic 204 incorporates the liquidity provider algorithm information 266 in the generated algorithms 284.

In another example, the order-dividing logic 222 obtains order-dividing information 256 from a user 206, divides single orders into smaller sub-orders based on the order-dividing information 256, generates sub-order algorithm information 268, and communicates the sub-order algorithm information 268 to the algorithm logic 204. The order-dividing logic 222 may divide the single orders into smaller sub-orders based on time intervals, size, or both.

In another example, the randomizing logic 224 obtains order-randomizing information 258 from a user 206, generates sub-order-randomizing information 264 based on the order-randomizing information 258, and communicates the generated sub-order-randomizing information 264 to the order-dividing logic 222. In this example, the sub-order algorithm information 268 is further based on the sub-order-randomizing information 264. The sub-order algorithm information 268 may comprise information to randomize sub-orders based on time intervals, fractional portions of the single order, or both.

In another example, the order-linking logic 226, obtains order-linking information 260 from a user 206, generates linked order information 270 based on the order-linking information 260, and communicates the linked order information 270 to algorithm logic 204. The linked order information 270 may comprise instructions for the algorithm logic 204 to generate a plurality of linked orders. When one order of the plurality of linked orders executes, the remaining orders of the plurality are canceled. The order-linking information 260 obtained from a user 206 may further comprise one or more previously executed orders on which to base the linked order information 270. For example, a user may elect to “execute remaining balance at market” after their algo has expired or run out of time.

In another example, the order-pricing logic 228 obtains order-pricing information 262 from a user 206, generates algorithm pricing information 272 based on the order-pricing information 262, and communicates the algorithm pricing information 272 to the algorithm logic 204. The order-pricing information 262 may comprise a price at which to buy, a price at which to sell, or both, or ranges of prices. In one example, the order-pricing information 262 may be based on current conditions in the liquidity market 210. In another example, the order-pricing information 262 may be based on a previous order or trade. In another example, the order-pricing information 262 may comprise a price to price at which to buy based on an offer, a price at which to sell based on a bid, or both. In yet another example, the order-pricing information 262 may comprise a price at which to buy based on a bid, a price at which to sell based on an offer, or both. In another example the order-pricing information 262 may comprise a midpoint between two other prices, for example between a bid price and an offer price.

In another example, the order-pricing logic 228 may be further configured to adjust algorithm pricing information 272 over time. In a further example, the order-pricing logic 228 may be further configured to adjust algorithm pricing information 272 incrementally in predetermined amounts. In a further example, the order-pricing logic 228 may be further configured to adjust algorithm pricing information 272 periodically at predetermined intervals of time. In another embodiment, the order-pricing logic 228 may be further configured to adjust algorithm pricing information 272 incrementally in predetermined amounts at predetermined intervals of time. One example is the “Transition Peg”, which is a variation of the “Peg” order. Thus, instead of sending a series of smaller orders to be executed with a fixed Peg price offset, the “Transition Peg” allows user to adjust the amount of Peg price offset for each subsequent small order. In one exemplary execution, instead of pegging a series of small orders to the prevailing Bid Price, +1 pip every 20 seconds, the Transition Peg user can peg to prevailing Bid Price +0 pips in the first 20 seconds, then to Bid +0.2 pips in the next 20 seconds, then to Bid +0.4 pip in the next 20 seconds, and so on. In a further example, the price changes in the Transition Peg may be triggered by market conditions.

In another example, the display logic 202 generates a plurality of trading strategies 258 which are communicated to a user 206. The algorithm logic 204 obtains strategy selection information 290 from the user 206. The strategy selection information 290 comprises information identifying at least one of the plurality of trading strategies 258. In this example, the algorithm logic 204 generates one or more trading algorithms 274 based on the strategy selection information 290 obtained from the user 206. The trade facilitating logic 208 facilitates trades 276 in a liquidity market 210 based on the one or more algorithms 274 generated by the algorithm logic 204. Strategies may be based on anyone or more of the order types disclosed above, e.g., TWAP, VWAP, etc. Alternately, a user may combine and customize one or more of the order types above and save this new trading strategy with a custom name.

In another example, the display logic 202 may be configured to generate both a plurality of trading strategies 258 and a plurality of user-configurable trading algorithm parameters 250, which are communicated to a user 206. The apparatus 200 obtains both strategy selection information 290 and algorithm parameter information 252 from the user 206. In this embodiment, the algorithm logic 204, generates one or more trading algorithms 274 based on both the selection information 290 and the algorithm parameter information 252 obtained from the user 206. The trade facilitating logic 208 facilitates trades 276 in a liquidity market 210 based on the one or more algorithms 274 generated by the algorithm logic 204.

FIG. 3 illustrates another exemplary embodiment comprising a method for generating a trading algorithm. At step 300, a plurality of user-configurable trading algorithm parameters 302 are generated. The user-configurable trading algorithm parameters 302 may be communicated to a user via a display unit, a loudspeaker, a communications network, any combination of the three, or via an equivalent communications technology. At step 304 input is obtained from the user. The user input comprises algorithm parameter information 306, which further comprises information defining at least one characteristic of at least one user-configurable trading algorithm parameter from the plurality of generated user-configurable parameters 302. At step 308 one or more trading algorithms 310 based on the algorithm parameter information 306 are generated. At step 312 trades 314 are facilitated in a liquidity market 210 based on the one or more trading algorithms 310.

A further embodiment comprises the forgoing steps and further comprises steps 316 to 328. At step 316 historical performance information 318 is obtained from the liquidity market 210. At step 320 the historical performance information 330 is analyzed and historical performance analysis 322 is generated. At step 324 one or more new algorithms 326 are generated based on the historical performance analysis 322. At step 328 new trades 330 are facilitated in a liquidity market 210 based on the one or more new algorithms 326.

A person skilled in the art will also understand that the above method may be implemented via a non-transitory computer-readable medium comprising executable instructions configured to cause one or more processing units to execute any or all of the above steps.

What is claimed is:

1. A computer-implemented method for generating one or more trading algorithms, comprising the steps of:
generating, via one or more processing units, display data representing a plurality of user configurable trading algorithm parameters;
obtaining, from a user, algorithm parameter information, wherein the algorithm parameter information comprises information defining at least one characteristic of at least one user configurable trading algorithm parameter of the plurality of user configurable trading algorithm parameters;
generating the one or more trading algorithms based, at least in part, on the algorithm parameter information; and
facilitating one or more trades in a liquidity market using the one or more generated trading algorithms.

2. The computer-implemented method of claim 1, wherein the liquidity market comprises a plurality of liquidity providers and a plurality of users.

3. The computer-implemented method of claim 1, further comprising the steps of:
obtaining historical performance information for the one or more generated trading algorithms;
analyzing the historical performance information for the one or more generated trading algorithms;
generating one or more new trading algorithms based on the analyzed historical performance information; and
facilitating one or more trades in a liquidity market using the one or more newly generated trading algorithms.

4. The computer-implemented method of claim 1, wherein one of the plurality of configurable algorithm parameters comprises a list of one or more liquidity provider counterparties, wherein the method further comprises:
obtaining, from a user, liquidity provider configuration information identifying one or more liquidity providers for inclusion in the list of one or more liquidity provider counterparties.

5. The computer-implemented method of claim 1, wherein the method further comprises:
dividing a single trade of the one or more trades into a plurality of smaller sub-trades.

6. The computer-implemented method of claim 5, wherein one of the plurality of configurable algorithm parameters comprises a time between the sub-trades.

7. The computer-implemented method of claim 6, wherein the method further comprises randomizing the time between sub-trades.

8. The computer-implemented method of claim 5, wherein one of the plurality of configurable algorithm parameters comprises a percentage of the single trade for each of the sub-trades.

9. The computer-implemented method of claim 8, wherein the method further comprises randomizing the percentage of the single trade for each of the sub-trades.

10. The computer-implemented method of claim 1, wherein the method further comprises the step of:
generating a plurality of linked orders, wherein execution of one of the plurality of linked orders cancels the remaining orders of the plurality of linked orders.

11. The computer-implemented method of claim 10, wherein the linked orders are generated from a previous order.

12. The computer-implemented method of claim 1, the method further comprising:
generating an order price, wherein the order price is based on a current market condition; and
the generated order price comprises at least one of:
a bid price; and
an offer price.

13. The computer-implemented method of claim 1, wherein at least one of the plurality of configurable algorithm parameters comprises at least one of:
a price at which to buy; and
a price at which to sell

14. The computer-implemented method of claim 13, wherein the price at which to buy comprises a bid price and the price at which to sell comprises an offer price.

15. The computer-implemented method of claim 13, wherein the price at which to sell comprises a bid price and the price at which to buy comprises an offer price.

16. The computer-implemented method of claim 13, wherein at least one of the following comprises a midpoint between two other prices:
the price at which to buy; and
the price at which to sell.

17. The computer-implemented method of claim 13, wherein at least one of the prices comprises a price selected from a previous order.

18. The computer-implemented method of claim 13, the method further comprising:
adjusting at least one order price based on current market conditions.

19. The computer-implemented method of claim 13, the method further comprising:
adjusting at least one order price to be lower or higher than a price upon which it is based.

20. The computer-implemented method of claim 13, the method further comprising:
adjusting at least one of the order prices over time, via the one or more trading algorithms.

21. The computer-implemented method of claim 20, the wherein the order price adjusts incrementally in predetermined amounts.

22. The computer-implemented method of claim 20, wherein the order price adjusts periodically at predetermined intervals of time.

23. The computer-implemented method of claim 20, wherein the order price adjusts incrementally in predetermined amounts at predetermined intervals of time.

24. A computer-implemented method for generating one or more trading algorithms, comprising the steps of:
generating, via one or more processing units, display data representing a plurality of trading strategies;
obtaining, from a user, trading strategy selection information, wherein the trading strategy selection information comprises information identifying one or more trading strategies of the plurality of trading strategies;
generating the one or more trading algorithms based, at least in part, on the trading strategy selection information; and
facilitating one or more trades in a liquidity market using the one or more generated trading algorithms.

25. The computer-implemented method of claim 24, wherein the liquidity market comprises a plurality of liquidity providers and a plurality of users.

26. The computer-implemented method of claim 24, further comprising the steps of:
obtaining historical performance information for the one or more generated trading algorithms;
analyzing the historical performance information for the one or more generated trading algorithms;
generating one or more new trading algorithms based on the analyzed historical performance information; and
facilitating one or more trades in a liquidity market using the one or more newly generated trading algorithms.

27. The computer-implemented method of claim 24, further comprising the steps of:
generating, via one or more processing units, display data representing a plurality of user configurable trading algorithm parameters;
obtaining, from a user, algorithm parameter information, wherein the algorithm parameter information comprises information defining at least one characteristic of at least one user configurable trading algorithm parameter of the plurality of user configurable trading algorithm parameters; and
wherein generating the one or more trading algorithms is also based on the algorithm parameter information.

28. The computer-implemented method of claim 27, further comprising the steps of:
obtaining historical performance information for the one or more generated trading algorithms;
analyzing the historical performance information for the one or more generated trading algorithms;
generating one or more new trading algorithms based on the analyzed historical performance information
facilitating one or more trades in a liquidity market using the one or more newly generated trading algorithms.

29. The computer-implemented method of claim 27, wherein the liquidity market comprises a plurality of liquidity providers and a plurality of users.

30. An apparatus comprising:
display data logic, configured to generate display data representing a plurality of user-configurable trading algorithm parameters;
algorithm logic, operatively connected to the display data logic, the algorithm logic being configured to generate one or more algorithms based on algorithm parameter information obtained from a user, wherein the algorithm parameter information defines at least one characteristic of at least one of a plurality of user-configurable trading algorithm parameters; and
trade facilitating logic, operatively connected to the algorithm logic, the trade facilitating logic configured to facilitate trades in a liquidity market, wherein the trades are based on the one or more algorithms generated by the algorithm logic.

31. The apparatus of claim 30, wherein the liquidity market comprises a plurality of liquidity providers and a plurality of users.

32. The apparatus of claim 30, further comprising:
performance analyzing logic, operatively connected to the algorithm logic, the performance analyzing logic configured to obtain and analyze historical performance information for the one or more generated trading algorithms, generate historical performance order information, and communicate the historical performance order information to the algorithm logic.

33. The apparatus of claim 30, further comprising:
liquidity provider logic, operatively connected to the algorithm logic, the liquidity provider logic configured to obtain, from a user, liquidity provider configuration information defining one or more liquidity providers as counterparties for the trades based on the one or more algorithms generated by the algorithm logic.

34. The apparatus of claim 30, further comprising:
order-dividing logic, operatively connected to the algorithm logic, the order-dividing logic configured to divide a single order into a plurality of smaller sub-orders.

35. The apparatus of claim 34, wherein one of the plurality of configurable algorithm parameters comprises a time between the sub-trades.

36. The apparatus of claim 34, further comprising:
randomizing logic, operatively connected to the order-dividing logic, the randomizing logic configured to randomize the time between the sub-orders.

37. The apparatus of claim 34, wherein one of the plurality of configurable algorithm parameters comprises a percentage of the single trade for each of the sub-trades.

38. The apparatus of claim 37, further comprising:
randomizing logic, operatively connected to the order-dividing logic, the randomizing logic configured to randomize the percentage of the single trade for each of the sub-trades.

39. The apparatus of claim 30, further comprising:
order-linking logic, operatively connected to the algorithm logic, the order-linking logic configured to generate linked order information, wherein linked order information defines a plurality of linked orders, wherein execution of one of the plurality of linked orders cancels the remaining orders of the plurality of linked orders.

40. The apparatus of claim 39, wherein the linked order information is generated from a previous order.

41. The apparatus of claim 30, further comprising:
order-pricing logic, operatively connected to the algorithm logic, the order-pricing logic configured to generate an order price based on one the of user configurable algorithm trading parameters, wherein the generated order price comprises at least one of:
a price at which to buy; and
a price at which to sell

42. The apparatus of claim 41, wherein the price at which to buy comprises a bid price and the price at which to sell comprises an offer price.

43. The apparatus of claim 41, wherein the price at which to sell comprises a bid price and the price at which to buy comprises an offer price.

44. The apparatus of claim 41, wherein at least one of the following comprises a midpoint between two other prices:
the price at which to buy; and
the price at which to sell.

45. The apparatus of claim 41, wherein at least one of the prices comprises a price selected from a previous order.

46. The apparatus of claim 41, the order-pricing logic further configured to define at least one order price based on current market conditions.

47. The apparatus of claim 41, the order-pricing logic further configured to define at least one order price to be lower or higher than another price upon which it is based.

48. The apparatus of claim 41, the order-pricing logic further configured to adjust at least one of the order prices over time.

49. The apparatus of claim 49, the wherein the order price adjusts incrementally in predetermined amounts.

50. The apparatus of claim 49, wherein the order price adjusts periodically at predetermined intervals of time.

51. The computer-implemented methods of claim 49, wherein the order price adjusts incrementally in predetermined amounts at predetermined intervals of time.

52. An apparatus comprising:
display data logic, configured to generate display data representing a plurality of trading strategies;
algorithm logic, operatively connected to trade facilitating logic, the algorithm logic configured to generate one or more algorithms based on trading strategy selection information obtained from a user, wherein the trading strategy selection information comprises information identifying one or more trading strategies of the plurality of trading strategies;
trade facilitating logic, operatively connected to the algorithm logic, the trade facilitating logic configured to facilitate trades in a liquidity market, wherein the trades are based on the one or more algorithms generated by the algorithm logic.

53. The apparatus of claim 53, wherein the liquidity market comprises a plurality of liquidity providers and a plurality of users.

54. The apparatus of claim 53, further comprising:
performance analyzing logic, operatively connected to the algorithm logic, the performance analyzing logic configured to obtain and analyze historical performance information for the one or more generated trading algorithms, generate historical performance order information, and communicate the historical performance order information to the algorithm logic.

55. The apparatus of claim 53, wherein:
the display data logic is further configured to generate display data representing a plurality of user-configurable trading algorithm parameters; and
the algorithm logic is further configured to generate the one or more algorithms also based on algorithm parameter information obtained from a user, wherein the algorithm parameter information defines at least one characteristic of at least one of a plurality of user-configurable trading algorithm parameters.

56. The apparatus of claim 56, further comprising:
performance analyzing logic, operatively connected to the algorithm logic, the performance analyzing logic configured to obtain and analyze historical performance information for the one or more generated trading algorithms, generate historical performance order information, and communicate the historical performance order information to the algorithm logic.

57. The apparatus of claim 56, wherein the liquidity market comprises a plurality of liquidity providers and a plurality of users.

58. A non-transitory computer-readable medium comprising executable instructions that when executed by one or more processing units cause the one or more processing units to carry out a method comprising:
generating display data representing a plurality of user configurable trading algorithm parameters;
obtaining algorithm parameter information, wherein the algorithm parameter information comprises information defining at least one characteristic of at least one user configurable trading algorithm parameter of the plurality of user configurable trading algorithm parameters;
generating the one or more trading algorithms based, at least in part, on the algorithm parameter information; and
facilitating one or more trades in a liquidity market using the one or more generated trading algorithms.

59. A non-transitory computer-readable medium comprising executable instructions that when executed by one or more processing units cause the one or more processing units to carry out a method comprising:
generating display data representing a plurality of trading strategies;
obtaining trading strategy selection information, wherein the trading strategy selection information comprises information identifying one or more trading strategies of the plurality of trading strategies;
generating the one or more trading algorithms based, at least in part, on the trading strategy selection information; and
facilitating one or more trades in a liquidity market using the one or more generated trading algorithms.
